(19) United States
(12) Patent Application Publication
(10) Pub. No.: US 2016/0371756 A1
(43) Pub. Date: Dec. 22, 2016

(54) SEAMLESS SHARING OF CUSTOMER SUPPORT CHAT SESSIONS

(71) Applicant: T-Mobile, USA, Inc., Bellevue, WA (US)

(72) Inventors: Ryan Yokel, Seattle, WA (US); Jennifer Prouty, Snoqualmie, WA (US)

(21) Appl. No.: 15/185,464

(22) Filed: Jun. 17, 2016

Related U.S. Application Data
(60) Provisional application No. 62/182,365, filed on Jun. 19, 2015.

(51) Int. Cl. G06Q 30/06; G06Q 10/10; G06Q 10/06; H04L 12/58; H04L 29/08

(52) U.S. Cl. CPC G06Q 30/0613; H04L 51/046; H04L 51/16; H04L 67/22; H04L 67/14; H04L 51/14; G06Q 10/06313; G06Q 10/1095

(57) ABSTRACT

The seamless sharing of a support chat session may enable a new customer service representative to assist a customer with an issue. Initially, a support chat session may be established between a support application of a customer service representative and a chat application of the customer. Subsequently, a request for sharing the support chat session to a new customer service representative may be received from the support application of the customer service representative. Accordingly, the session state information for the support chat session may be saved, in which the session state information includes a chat log of text messages exchanged between the customer and the customer service representative. Following an indication from the new customer service representative, the new customer service representative may be placed into the support chat session.

### CROSS REFERENCE TO RELATED PATENT APPLICATION

This application claims priority to U.S. Provisional Patent Application No. 62/182,365, filed on Jun. 19, 2015, entitled “Messaging with Customers,” which is hereby incorporated by reference in its entirety.

### BACKGROUND

Mobile devices are integral to the daily lives of most users. Mobile devices are used to make voice calls, check email and text messages, update social media pages, stream media, browse websites, and so forth. As a result, users of mobile devices expect a mobile telecommunication carrier to provide constant and reliable telecommunication and data communication services at all times.

The reliability of telecommunication and data communication services may be affected by multiple factors, such as geography and terrain, device features and capabilities, as well as network infrastructure and network coverage deployment. With the widespread use of chat software, many users prefer to chat with customer service representatives of a wireless communication carrier to remedy their service issues. In certain instances, a frontline customer service representative who is in a chat session with a customer may encounter difficulty while trying to diagnose and solve a service issue of the customer. In such instances, the frontline customer service representative may be forced to end the chat session with the customer so that the customer may initiate another chat session with a different customer service representative who is more familiar with the service issue. However, because the new customer service representative is unfamiliar with the service issue of the customer, the customer may need to explain or recap the same service issue to the new customer service representative. Accordingly, the use of text chat to provide customer support may on occasions lead to frustration for both the user and the customer care representatives.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture for deploying a support session engine that seamlessly shares a support chat session with a customer between multiple customer service representatives.

FIG. 2 is a block diagram showing various components of one or more illustrative computing devices that implement the support session engine for seamlessly sharing support chat sessions.

FIG. 3 shows illustrative chat session interfaces for seamlessly sharing a support chat session with a customer between multiple customer service representatives.

FIG. 4 is a flow diagram of an example process for seamlessly sharing a support chat session with a customer between multiple customer service representatives.

FIG. 5 is a flow diagram of an example process for initiating an in-store interaction between a customer and an in-store customer service representative via a support chat session.

FIG. 6 is a flow diagram of an example process for collecting session state information of a support chat session for sharing with another customer service representative.

FIG. 7 is a flow diagram of an example process for inviting a customer to engage in a support chat session or an in-store interaction with a customer service representative.

FIG. 8 is a flow diagram of an example process for a monitoring agent to provide synchronous or asynchronous feedback regarding a support chat session between a customer and a customer service representative.

### DETAILED DESCRIPTION

This disclosure is directed to techniques for seamlessly sharing a support chat session with a customer between multiple customer service representatives. The customer may contact a customer service representative of a wireless communication carrier via a chat session when the customer encounters a service issue. In some instances, the issue may be the result of a network coverage problem that affect the ability of a user device of the customer to access communication services provided by the wireless communication carrier. In other instances, the issue may be related to compatibility of a user device with the service, return, exchange, or upgrade policies of the wireless telecommunication carrier. In various embodiments, the customer may initiate the chat session via a customer chat application. In some embodiments, the customer chat application may reside on the user device of the customer. In such embodiments, the customer chat application may have been pre-installed on the user device by the wireless communication carrier or downloaded and installed by the user. In other embodiments, the customer chat application may be installed on another use device that is controlled by the customer.

The customer may use the customer chat application to initiate a support chat session with a customer service representative of the wireless telecommunication carrier. The customer service representative may use a support application on a customer care terminal to carry out the chat session with the customer. During the chat session, the support application may be use by the customer service representative to initiate a sharing of the support chat session with another customer service representative. In other words, the customer service representative may bring another customer service representative into the chat session to join the chat. The customer service representative may initiate such a share in an instance in which the representative feels that the customer may benefit from expertise of another representative to resolve the issue. Upon receiving such a request, a support session engine of the wireless telecommunication carrier may forward the session state information for the chat session to a customer care terminal of an escalated customer service representative.

The session state information may include a chat log of the text messages exchanged during the chat session and other information that are relevant to the resolution of the issue. Accordingly, after reviewing the session state information, the escalated customer service representative may join into the chat session with the customer via a corresponding support application. In this way, the escalated customer service representative may seamlessly join the chat session with the customer. In some embodiments, the escalated customer service representative may further initiate a sharing of the chat session with yet another customer service representative if it is desirous to do so. In other words, by saving and forwarding the session state information on a repeated basis, the support session engine may support multiple customer service representatives joining in and chatting with the customer in a single support chat session.

In further embodiments, a customer service representative who is engaged in a support chat session with the customer may initiate an in-store interaction for the customer. In additional embodiments, a monitoring agent may review the chat log and/or other relevant information of a support chat session between the customer and a customer service representative in real-time or on a periodic basis. The monitoring agent may be a live person (e.g., a supervisor) or an analytic software (e.g., a data analysis application). Accordingly, in instances in which the support chat session is being reviewed in real-time, the monitoring agent may provide synchronous feedback on the session. However, in instances in which the support chat session is being reviewed on a periodic basis, i.e., in non-real time, the monitoring agent may provide asynchronous feedback on the session. The feedback may be routed for viewing by the customer service representative, and in some instances also by the customer.

Thus, the seamless sharing of a support chat session with a customer between multiple customer service representatives may enable new customer service representatives to assist a customer with a service issue. In some embodiments, the new customer service representative may be an escalated customer service representative with the expertise to better assist the customer with the service issue. By reviewing the saved chat log and other information, each new customer service representative is able to assist the customer using the same chat session without having the customer repeating a description of the service issue. Further, a support chat session may be used to seamlessly initiate an in-store interaction between the customer and an in-store customer service representative. Thus, the techniques may increase customer satisfaction and customer retention by providing attentive service to the customer. The techniques described herein may be implemented in a number of ways. Example implementations are provided below with reference to the following figures.

### Example Architecture

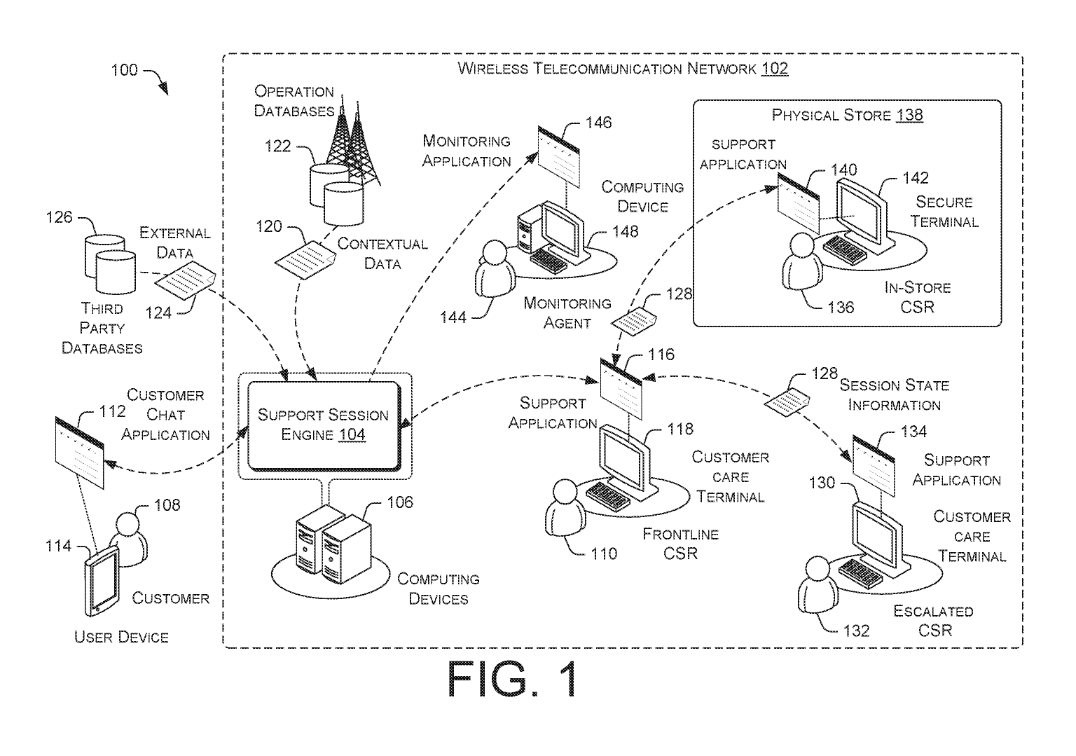

FIG. 1 illustrates an example architecture 100 for deploying a support session engine that seamlessly shares a support chat session with a customer between multiple customer service representatives. The architecture 100 may include a wireless telecommunication network 102 that is operated by a wireless telecommunication carrier. The wireless telecommunication network 102 may provide a wide range of mobile communication services, as well as ancillary services and features, to subscribers and associated mobile device users. In various embodiments, the wireless telecommunication network 102 may provide wireless communication between multiple user devices. Further, the wireless telecommunication network 102 may also provide communications between the multiple user devices and other user devices that are serviced by other telecommunication networks. In various embodiments, the user devices may include mobile handsets, smart phones, tablet computers, personal digital assistants (PDAs), smart watches, and/or electronic devices.

The wireless telecommunication network 102 may be implemented using multiple interconnected networks. In various embodiments, the wireless telecommunication network 102 may include multiple Radio Access Networks (RANs). The RANs may be connected to each other via regional ground networks. In turn, the regional ground networks may be connected to a core network by a wide area network (WAN). Each regional portion of the wireless telecommunication network 102 may include one or more RANs and a regional circuit and/or packet switched network and associated signaling network facilities.

A RAN of the wireless telecommunication network 102 may include a number of base stations. In some embodiments, the base stations may be in the form of eNodeB nodes. Each eNodeB node may include a base transceiver system (BTS) that communicates via an antennae system over an air-link with one or more user devices that are within range. The BTS may send radio communication signals to user devices and receive radio communication signals from user devices. The radio access networks may carry the communications for the user devices between the respective base stations and the core network. The core network may connect to a public packet data communication network, such as the Internet. Packet communications via the RANs, the core network, and the Internet may support a variety of services through the wireless telecommunication network 102.

The wireless telecommunication network 102 may further include a support session engine 104. The support session engine 104 may execute on one or more computing devices 106. The one or more computing devices 106 may include general purpose computers, such as desktop computers, tablet computers, laptop computers, servers, or other electronic devices that are capable of receive inputs, process the inputs, and generate output data. In still other embodiments, the one or more computing devices 106 may be virtual computing devices in the form of computing nodes, such as virtual machines and software containers. In various embodiments, the computing devices 106 may be controlled by a wireless telecommunication carrier that provides the wireless telecommunication network 102, and/or controlled by a third-party entity that is working with the mobile telecommunication carrier.

The support session engine 104 may support chat sessions between a customer 108 and various customer service representatives, such as a frontline customer service representative 110. In various embodiments, the customer 108 may use a customer chat application 112 on the user device 114 to contact the support session engine 104 in order to initiate a support chat session. The customer chat application 112 may communicate with the support session engine 104 via a network connection that includes the wireless telecommunication network 102, an Internet connection, or a combination of both. The customer 108 may initiate the support chat session to seek help regarding an issue that customer is experiencing with the user device 114 or another user device. The customer chat application 112 may be a standalone application or a part of a customer support application that is provided to the customer 108 by the wireless telecommunication carrier. In turn, the support session engine 104 may select the frontline customer service representative 110 to engage in a chat session with the customer 108. The selection of the customer service representative 110 by the support session engine 104 may be performed on a round robin basis, on a random basis, or based on the expertise of the various customer service representatives.

Upon the selection of the frontline customer service representative 110, the support session engine 104 may inform the representative to engage in the session with the customer 108 via a support application 116. The support application 116 may reside on the customer care terminal 118 of frontline customer service representative 110. In order to resolve the issue, the customer service representative 110 may use the support application 116 to request contextual data 120 from the operation databases 122 that are relevant to the customer 108 and/or the user device 114.

In various embodiments, the contextual data 120 may include relevant network information, device information, and/or user account information. The network information may include information regarding the technical and operational status of the wireless telecommunication network. For example, network information of the network may indicate that Long-Term Evolution (LTE) spectrum coverage (or other spectrum coverage) is unavailable in a particular geographical area or that a network node was temporarily overwhelmed with network traffic at a particular time due to a major event. The device information of user devices may indicate the technical capabilities, feature settings, and operational statuses of user devices. For example, device information for the user device 114 may indicate that Wi-Fi calling is enabled on the user device or that the user device is capable of using a specific communication band provided by the wireless telecommunication network. In other examples, the device information for the user device 114 may indicate that Wi-Fi calling is disabled on the user device, a developer mode is active on the user device, a location tracking service is active on the user device, and/or so forth. The user account information for a customer may include account details of multiple users, such as account type, billing preferences, service plan subscription, payment history, data consumed, minutes of talk time used, and/or so forth. For example, the account data of the customer 108 may indicate that the user has a postpaid account and that the user is current with payments for the subscribed service plan.

The operation databases 122 may also store operation information for the physical stores of the wireless telecommunication carrier, such as physical store 138. The operation information may include inventory of devices and device accessories of each physical store, work schedules of customer service representatives that work at each physical store, technical proficiencies and expertise of the customer service representatives that work at each physical store, customer appointment calendars of the customer service representatives that work at each physical store, and/or so forth.

In some embodiments, the customer service representative 110 may use the support application 116 to request external data 124 from the third-party databases 126. Each of the third-party databases 126 may be a database that is provided by a party other than the wireless telecommunication network 102. For example, a third-party database may be provided by a third-party vendor, a third-party contractor, a government entity, another telecommunication carrier, a social media website, and/or so forth. The external data 124 may be network-related information, device-related information, and/or user-related information that supplement the contextual data 120. In some instances, the external data 124 may include regulatory information for networks and devices, device manufacturer information, credit information on users, and/or so forth.

In other instances, the external data 124 may include relevant social media data. The social media data may be provided by social networking portals. Social media portals may include a portal that is established by the wireless telecommunication carrier, a portal that is maintained by a third-party service provider for users to share social media postings, and/or a portal that is created and maintained by a particular user solely for the particular user to present social postings. The social media portals may be mined by the support session engine 104 for external data that is relevant to the issue that the customer 108 is experiencing with the user device 114 or another user device. For example, social media posting may indicate that a particular geographical area has poor network coverage, a particular model of a user device has below average signal reception, a certain operating system of a user device is prone to a specific software virus, and/or so forth. Accordingly, the support session engine 104 may use a correlation algorithm to correlate the relevant information mined from the social media portals to the customer 108 and/or the user device 114. The support engine 104 may aggregate and store the social media data mined from the social media portals for further distribution and analysis. Accordingly, the relevant information may be provided by the support session engine 104 to the customer care terminal 118 for presentation to the frontline customer service representative 110.

In alternative embodiments, the support application 116 may automatically request at least some of the contextual data 120 and/or the external data 124 and provide such data for viewing by the customer service representative 110 on the support application 116. The contextual data 120 may be used by the customer service representative 110 to determine a solution for the issue.

At some point, the customer service representative 110 may decide to share the support chat session between the customer 108 and the representative with another customer service representative, such as the escalated customer service representative 132. For example, the customer service representative 110 may initiate such sharing when the representative 110 feels that the customer may benefit from the additional or more in-depth expertise of another representative to resolve the issue.

Upon receiving such a share request, the support session engine 104 may forward the session state information for the chat session to a customer care terminal 130 of the escalated customer service representative 132. The escalated customer service representative 132 may use a support application 134 to view the session state information 128.

Accordingly, after reviewing the session state information 128, the escalated customer service representative 132 may use the support application 134 to indicate to the support session engine 104 that the representative is ready to join the frontline customer service representative 110 in the chat session. Subsequently, the support session engine 104 may provide the escalated customer service representative 132 with access to the chat session that is already in progress. In this way, the escalated customer service representative 132 may seamlessly join the chat session with the customer 108. In some embodiments, the escalated customer service representative 132 may further request yet another customer service representative to join in the chat session if it is desirous to do so. In other words, by saving and forwarding the session state information on a repeated basis, the support session engine 104 may support multiple customer service representatives chatting with a customer in a single support chat session.

In alternative embodiments, a customer service representative 110 in the chat session with the customer 108 may initiate an in-store interaction for the customer. For example, the customer service representative 110 may determine that the customer has a device issue that is best resolved in person at a physical store of the wireless telecommunication carrier. Accordingly, the customer service representative 110 may send an in-store interaction request to the support session engine 104. In response to the in-store interaction request, the support session engine 104 may provide a recommendation of a physical store and a scheduled time based on a detected geographical location of the customer. The recommendation may be displayed by the customer chat application 112 on the user device 114. Upon receiving a confirmation that the customer has accepted the recommendation, the support session engine 104 may assign an in-store customer service representative to interact with the customer at the scheduled time. For example, an in-store customer service representative 136 of a physical store 138 may be selected by the support session engine 104 to provide the in-store support to the customer 108. As such, the in-store customer service representative 136 may receive a task notification and a scheduled time for the task on a support application 140 of an in-store secure terminal 142. The task notification may include the session state information 128, which may indicate the nature of the task that the in-store customer service representative 136 is to perform for the customer 108.

In alternative embodiments, the in-store interaction request may not rely on the expertise of a particular in-store customer service representative. In such embodiments, the task notification may be assigned to a common task queue that is shared among multiple in-store customer service representatives. The task notification may be correlated with a device identifier of the user device 114 and/or a customer identifier of the customer 108. In this way, the customer 108 may show up at the physical store 138 with the user device 114 at any time, and present the corresponding identification to obtain the in-store service from any available customer service representative without having to wait in line.

In additional embodiments, each support chat session between a customer and a customer service representative may be reviewed in real-time or on a periodic basis by a monitoring agent. The review of a support chat session may involve the reviewing of the support chat session and other session state information relevant to the support chat session. In some instances, the monitoring agent may be a live person, such as a manager or a supervisor. For example, the monitoring agent 144 may review the chat log of the support chat session using a monitoring application 146 on the computing device 148. In other instances, the monitoring agent may be an analytic software, such as a data analysis application. Accordingly, in instances in which the support chat session is being reviewed in real-time, the monitoring agent may provide synchronous, i.e., live, feedback on the session. However, in instances in which the support chat session is being reviewed on a periodic basis, i.e., in non-real time, the monitoring agent may provide asynchronous, i.e., post-event, feedback on the session. The feedback may be routed for viewing by the customer service representative and/or the customer. For example, the monitoring agent may provide a live feedback as a chat message in the support chat session, such that the chat message is visible to both the customer support representative and the customer. Alternatively, the monitoring agent may provide a live feedback or post-event feedback to the customer support representative via an internal messaging system that is not visible to the customer.

### Example Computing Device Components

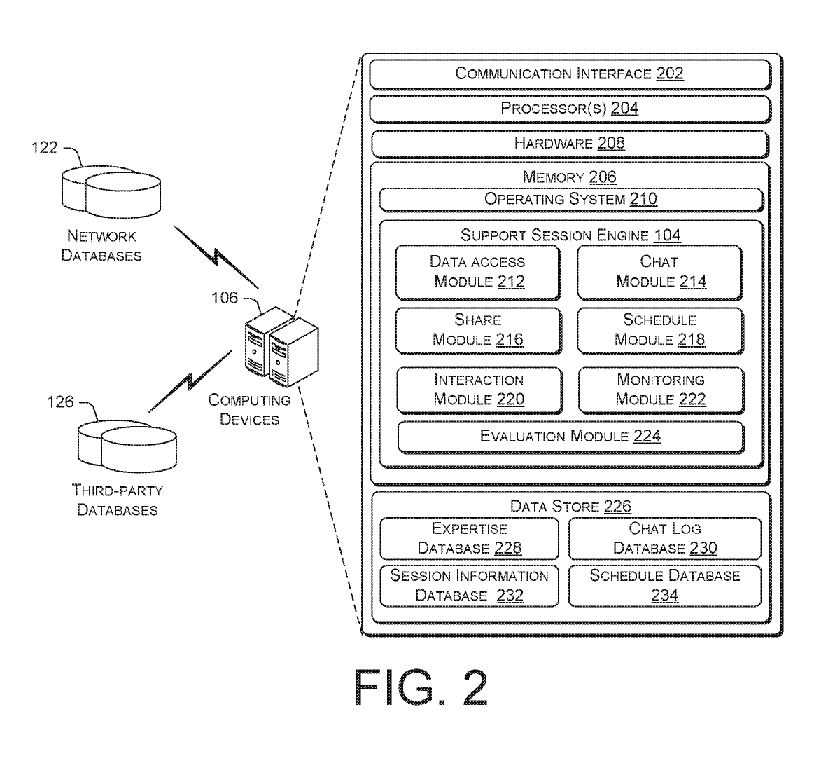

FIG. 2 is a block diagram showing various components of one or more illustrative computing devices that implement the support session engine for seamlessly sharing support chat sessions. The computing devices 106 may include a communication interface 202, one or more processors 204, memory 206, and hardware 208. The communication interface 202 may include wireless and/or wired communication components that enable the server to transmit data to and receive data from other networked devices. The hardware 208 may include additional hardware interface, data communication, or data storage hardware. For example, the hardware interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The processors 204 and the memory 206 of the computing devices 106 may implement an operating system 210 and the support session engine 104. The operating system 210 may include components that enable the computing devices 106 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The support session engine 104 may include a data access module 212, a chat module 214, a share module 216, a schedule module 218, an interaction module 220, a monitoring module 222, and an evaluation module 224. The modules may include routines, program instructions, objects, and/or data structures that perform particular tasks or implement particular abstract data types. The memory 206 may also include a data store 226 that is used by the support session engine 104.

The data access module 212 may retrieve data from the operation databases 122 and the third-party databases 126. In various embodiments, the data access module 212 may retrieve data that are relevant to a particular user device or customer from the databases in response to commands from chat module 214 or the share module 216. The relevant data for a user device or the customer may include any of the contextual data 120 and the external data 124 that are related to the provision of telecommunication services to the user device by the wireless telecommunication network 102.

In some embodiments, the data access module 212 may have the ability to directly query a user device for device information. In such embodiments, a query that is initiated by the data access module 212 may be received by a device management application on the user device. In turn, the device management application may provide a response that includes the device information being queried. For example, the data access module 212 may initiate a query to determine whether Wi-Fi calling is enabled on a user device, and the device management application may respond with the Wi-Fi calling enablement status of the user device. In at least one embodiment, the user may have the ability to select whether device management application is to respond to queries from the data access module 212 through a configuration setting of the application. In this way, the user may be given an opportunity to opt out of providing information to the data access module 212.

The chat module 214 may host chat sessions that are accessible by the customers and the customer service representatives via chat client applications. For example, the customer 108 may initiate and participate in a chat session through the customer chat application 112. Likewise, the frontline customer service representative 110 may initiate and participate in a chat session through the support application 116. The chat session may be established such that the customer 108 and the customer service representative 110 may use corresponding participant identifiers to participate in session. In some instances, the chat module 214 may authenticate the identification credentials provided by each of the customer 108 and the customer service representative 110 prior to establishing the chat session. The chat sessions may be implemented by the chat module 214 using various protocols, such as the Session Initiation Protocol (SIP), SIP Instant Messaging and Presence Leveraging Extensions (SIMPLE), Application Exchange (APEX), Instant Messaging and Presence Protocol (IMPP), Extensible Messaging and Presence Protocol (XMPP), or other messaging protocols. The chat module 214 may further archive the text messages that are exchanged between customers and customer service representatives. In such instances, the text messages may be stored as chat logs that are tagged with customer identifiers, customer service representative identifiers, dates and times, chat session identifiers, and/or other identification information. Such identification formation may be used to query and retrieve specific chat logs. In some embodiments, the chat module 214 may use encryption or security algorithms to ensure that the exchanged text message are secured from unauthorized viewing. The chat module 214 may select the frontline customer service representative 110 from multiple available customer service representatives on a round robin basis, random basis, or based on the expertise ratings of various available customer service representatives. In the latter scenario, the customer 108 may select an issue from a predetermined menu list or state an issue that is automatically recognized by a machine learning algorithm of the chat module 214 during the initiation of a chat session. In turn, the chat module 214 may select an available customer service representative with an expertise rating for selected issue that is above a certain threshold to participate in the chat session with the customer.

The share module 216 may enable new customer service representatives to join existing chat sessions. In other words, the share module 216 may provide ways for an existing customer service representative to share an existing support chat session with a new customer service representative. In at least one scenario, the share module 216 may receive a share request for a chat session that is initiated by the frontline customer service representative 110. In response to the share request, the share module 216 may search for a new customer service representative to join in the chat session. In various embodiments, the share module 216 may initially search for suitable customer service representatives that are currently available. Each suitable customer service representative may have specific expertise or skill that is valuable in providing additional assistance to the customer. Accordingly, the share request from the frontline customer service representative 110 may include an indicating that the representative is seeking another representative with expertise in a particular expertise category. A customer service representative may be currently available if the representative is registered as ready, e.g., login in, with the chat module 214. Subsequently, the share module 216 may search among the available customer representatives for a suitable new customer service representative. In various embodiments, the search may be performed on a round robin basis, on a random basis, or based on expertise descriptors in the form of the expertise ratings of the various customer service representatives stored in an expertise database 228. In one instance, the share module 216 may select an available customer service representative that has a higher expertise rating with the issue than the original customer service representative as the new customer service representative. The available customer service representative may be in various departments of the wireless telecommunication carrier, such as network operations, in-store retail, financial, care, retention, and/or so forth.

Once the new customer service representative is located, the share module 216 may forward the session state information to the new customer service representative. For example, the share module 216 may forward the session state information to the escalated customer service representative 132. In turn, the escalated customer service representative 132 may use a support application 134 to view the session state information 128. In various embodiments, the session state information 128 may include a chat log of the chat session and other information that are relevant to the resolution of the issue. The information may include an identifier of each customer service representative that participated in the support chat session with the customer. The information may further include notations on the customer 108 that are created by the frontline customer service representative 110. The notations may record subject observations of the customer service representative 110 on the customer 108. For example, the notifications may include notes on communication styles that work well with the customer 108, notes on the likes and dislikes of the customer 108, and/or so forth. Additionally, the information may include problem information as documented by the frontline customer service representative 110. The problem information may recite factual data about the issue, such as date and time the issue first occurred, the location of the affected user device when the issue occurred, the duration of the issue, the symptoms experienced by the customer 108 with respect to the issue, attempted solutions for the issue, and/or so forth. In some instances, the information may include at least some information from the contextual data 120 and the external data 124. In such instances, the share module 216 may use the data access module 212 to obtain the latest updates to the contextual data 120 and the external data 124 prior to forwarding the session state information to the support application 134 of the customer service representative 132.

Following review of the session state information 128, the escalated customer service representative 132 may use the support application 134 to indicate to the share module 216 that the new representative is ready to replace the frontline customer service representative 110 in the chat session. Subsequently, the share module 216 may provide the escalated customer service representative 132 with access to the chat session that is already in progress. In this way, the escalated customer service representative 132 may seamlessly join the chat session with the customer 108. In some instances, if the escalated customer service representative 132 decides after reviewing the session state information 128 to decline taking over the chat session, the representative 132 may send a decline indication to the share module 216. In alternative instances, the representative 132 may decline to join the chat session by failing to provide an acceptance indicator for the chat session in a predetermined amount of time. In turn, the share module 216 may initiate another search for an available and suitable customer service representative to join the chat session. The share module 216 may record the refusal by the customer service representative 132 to join the chat session in the expertise database 228. The information stored in the expertise database 228 may be used to rate the performance of the customer service representative. For example, the refusal as recorded in the expertise database 228 may negatively impact an expertise rating of the customer service representative 132.

In additional embodiments, the share module 216 may enable a customer to resume a support chat session with a customer service representative or a new customer service representative. In such embodiments, the customer 108 may send a chat message to a customer service representative during a chat support session requesting to suspend the session for later resumption. In turn, the customer service representative may request a chat resumption identifier from the share module 216. The chat resumption identifier may be a unique alphanumeric identifier that is generated from the share module 216. For example, the chat resumption identifier may be a session identifier, a case number, or some other unique identifier. The share module 216 may associate the chat resumption identifier with the session state information of the support chat session. The customer service representative may provide the chat resumption identifier to the customer 108 via the chat support session prior to the session being terminated.

Subsequently, when the customer 108 is ready to resume the support chat session, the customer 108 may initiate a chat resumption request using an interactive interface provided by the customer chat application 112. As a part of the chat resumption request, the customer 108 may provide the chat resumption identifier. In turn, the customer chat application 112 may send the chat resumption request and the chat resumption identifier to the support session engine 104. In response to the request, the share module 216 may determine whether one or more customer service representatives that previously chatted with the customer 108 is available. If multiple customer service representatives are available, the share module 216 may select one of these available customer service representatives. In various embodiments, an available customer service representative may be selected on a random basis unless the customer service representative that obtained the chat resumption identifier for the customer is available. However, when only one previous customer service representative is available, the share module 216 may automatically select the customer service representative. In an instance in which no previous customer service representatives are available, the share module 216 may select a new customer service representative that has the suitable expertise to join the chat support session. Once a customer service representative is selected, the share module 216 may forward the chat session information of the previous support chat session to the customer service representative. Further, the share module 216 may initiate the representative joining the support chat session in the same manner as previously described.

The schedule module 218 may be used by a customer service representative in a chat session with a customer to initiate an in-store interaction for the customer. In at least one scenario, the customer service representative 110 may determine that the customer has a device issue that is best resolved in person at a physical store of the wireless telecommunication carrier. Accordingly, the customer service representative 110 may send an in-store interaction request to the schedule module 218. The interaction request may in include request information that outline a nature of the issue, a resolution for the issue, personnel support for resolving the issue, material support for resolving the issue, a specific store location, a preferred time for the visit to the physical store, and/or an estimated amount of time for resolving the issue. For example, the request information may indicate that the customer 108 wants an in-store customer service representative to reset the user device 114 to factory default setting. In another example, the interaction request may indicate that the customer 108 is to be provided with a replacement charging cable under warranty. In various embodiments, the interaction request may be initiated via an interactive interface provided by the support application 116. The support application 116 may include pull down menus, data entry fields, and/or other data interfaces that enables the customer service representative 110 to outline the information associated with the request. Alternatively or concurrently, the request information may include the session state information 128 of the chat session. In some instances, the schedule module 218 may automatically detect a current geographical location of the user device 114, and select an open physical store at a location that is closest to the current geographical location of the user device 114. The schedule module 218 may further verify that the open physical store has an available customer service representative to assist the customer at the preferred time for the store visit before selecting the store. However, in other instances, the customer service representative may select an open physical store based on a desired location or geographical area indicated by an input of the customer.

In response to the in-store interaction request, the schedule module 218 may provide a recommendation of a physical store and a scheduled time. The recommendation may be displayed by the customer chat application 112 on the user device 114. Upon receiving a confirmation that the customer has accepted the recommendation, the schedule module 218 may assign an in-store customer service representative to interact with the customer at the scheduled time. For example, an in-store customer service representative 136 of a physical store 138 may be selected by the support session engine 104 to provide the in-store support to the customer 108. The representative 136 may have been selected based on the expertise of the representative in solving problems affecting devices that execute a particular operating system. As such, the in-store customer service representative 136 may receive a task notification and a scheduled time for the task on a support application 140 of an in-store secure terminal 142. Further, the request information and/or the session state information 128 of the chat session may be forwarded to the support application 140 of the in-store customer service representative 136. The in-store customer service representative 136 may have the option of decline to participate in the in-store interaction with the customer 108. Upon receiving an indication from the in-store customer service representative 136 has declined the in-store interaction session, the schedule module 218 may assign a new in-store customer service representative to interact with the customer at the scheduled time. Further, the refusal of the in-store customer service representative 136 to participate may be recorded by the schedule module 218 in the expertise database 228. The information stored in the expertise database 228 may be used to rate the performance of the in-store customer service representative. For example, the refusal as recorded in the expertise database 228 may negatively impact an expertise rating of the in-store customer service representative 126.

In alternative embodiments, the in-store interaction request may not rely on the expertise of a particular in-store customer service representative. For example, the task may be providing a replacement charging cable. In such embodiments, the task notification, along with the request information and/or the session state information 128, may be assigned to a common task queue that is shared among multiple in-store customer service representatives. The task notification may be correlated with a device identifier of the user device 114 and/or a customer identifier of the customer 108. In this way, the customer 108 may show up at the physical store 138 with the user device 114 at any time, and present the corresponding identification to obtain the in-store service from any available customer service representative.

The interaction module 220 may automatically determine whether a customer is due for an interaction with a customer service representative to resolve an issue related to a user device of the customer. The interaction module 220 may use a data analysis algorithm to analyze the information from the operation databases 122 or the third-party databases 126 that are relevant to the user device of the customer. By analyzing the information from the various databases, the data analysis algorithm may identify an issue that may affect the user device. For example, the issue may be a hardware issue, such as a user device charging cable or a battery recall that is identified based on a third-party database 126 in the form of a manufacturer database. In another example, the issue may be a software problem or a software setting problem that causes the user device to be susceptible to a particular malicious attack, in which the issue is identified based on information from an operation database 122 that is a device information database. However, in other examples, issues that relate to the user device may be detected based on network information, device information, user account information, social media information, and/or so forth as stored in the databases. For example, a hardware issue may be detected when information in a device operation database shows that the device has LTE capability, but information in the network operation database shows that the device is connected to a wireless communication network of the telecommunication carrier via a 2G network connection. In various embodiments, the data analysis algorithm may make use of techniques such as supervised learning, unsupervised learning, semi-supervised learning, naïve Bayes, Bayesian networks, decision trees, neural networks, fuzzy logic models, and/or probabilistic classification models to identify the issues.

Following the identification of an issue that relates to the user device, the interaction module 220 may use the chat module 214 to automatically send a prompt message to a customer chat application of the user device. In instances in which the issue may be resolved using a support chat session, the prompt message may state the nature of the issue and invite the customer to initiate the support chat session with a customer service representative. For example, if there is a faulty software setting on the user device, the prompt message may suggest that the customer enter into a support chat session to have a customer representative guide the customer to fix the faulty software setting. However, in instances in which the issue is best resolved via an in-store interaction, the prompt message may state the nature of the issue and invite the customer to participate in an in-store interaction with an in-store customer service representative at a physical store. For example, the prompt message may indicate that the customer can receive a replacement for a recalled charging cable or battery free of charge at a physical store. In still other examples, the prompt message may enable the customer to use different reply messages to indicate whether the customer desires to engage in a support chat session or an in-store interaction even when the issue is resolvable via the support chat session.

The customer may choose to ignore the prompt message, reject the invitation in the prompt message, or accept the offer in the prompt message. For example, the prompt message may specify that the customer may accept the offer by sending an acceptance message with the text “okay” back to the interaction module 220, or reject the invitation by sending a refusal message with the text “no thanks” back to the interaction module 220 via the customer chat application. The interaction module 220 may automatically recognize such messages based on the content and the device identifier of the user device, and take the appropriate action. In a scenario in which the interaction module 220 receives an acceptance message, the interaction module 220 may cause a customer service representative to be assigned to interact with the customer via a support chat session or the in-store interaction. In various embodiments, a customer service representative for the support chat session may be assigned by the chat module 214, while an in-store customer service representative may be assigned by the schedule module 218. With respect to the in-store interaction, the interaction module 220 may use a current geolocation of the user device to assign an available in-store customer service representative at a closest physical store that is equipped to resolve the issue related to the user device. In at least some embodiments, the customer service representative may be selected from among multiple customer representatives based on the expertise ratings of the representatives in dealing with the issue. In other words, the selected customer service representative may be an available representative that has the most expertise in dealing with the issue. However, if the interaction module 220 receives a refusal message, the interaction module 220 may store an indication of the refusal so that no future prompt messages regarding the issue is generated for the customer by the interaction module 220.

In instances in which the issue is best resolved via an in-store interaction, the interaction module 220 may use the geolocation of the user device to control the timing of the prompt message. In such instances, the interaction module 220 may ascertain whether the geolocation of the user device is within a predetermined distance of a physical store with an in-store customer service representative and/or item inventory to resolve the issue related to the user device. Thus, if the interaction module 220 determines that the user device is within the predetermined distance of such a physical store, the interaction module 220 may initiate the transmission of the prompt message to the customer chat application on the user device. The interaction module 220 may repeat the sending of such prompt messages to the customer chat application as the user device comes within the predetermined distance to multiple suitable physical stores until a refusal message from the user device with respect to the issue is received by the interaction module 220.

The monitoring module 222 may be used to review the support chat sessions between the customers and the customer service representatives may be reviewed in real-time or on a periodic basis. The review of a support chat session may involve the reviewing the chat log of the chat session and other session state information that are relevant to the support chat session. In some embodiments, the monitoring module 222 may display a selected chat session and/or other information on a monitoring application (e.g., monitoring application 146) of a live person. Accordingly, in instances in which the support chat session is being reviewed in real-time, the live person may provide synchronous, i.e., live, feedback on the session. However, in instances in which the support chat session is being reviewed on a periodic basis, i.e., in non-real time, the live person may provide asynchronous, i.e., post-event, feedback on the session.

In other embodiments, the monitoring module 222 may be an analytic software, such as a data analysis application. For example, the data analysis module may determine from network contextual information that the likely cause of the issue experienced by the user device 114 is a network outage. In another example, the data analysis module may determine from the messages exchanged in a chat session that the customer 108 may benefit from a consultation with a different customer service representative. Accordingly, in instances in which the support chat session is being reviewed in real-time, the monitoring module 222 may provide synchronous, i.e., live, feedback on the session. However, in instances in which the support chat session is being reviewed on a periodic basis, i.e., in non-real time, the monitoring module 222 may provide asynchronous, i.e., post-event, feedback on the session.

In various embodiments, the feedback that is provided by a live person or generated by the monitoring module 222 for a chat session may be routed for viewing by the customer service representative and/or the customer. In such embodiments, the monitoring agent 144 may provide instruction that direct the routing of the feedback to one or more specific recipients. The feedback for the customer service representative may include hints of questions to ask the customer, tips on dealing with the customer, suggestions of alternative remedies to the issue affecting the customer, links to relevant contextual data related to the issue of the customer, and/or so forth. The feedback for the customer may include suggestions of alternative remedies to the issue of the customer, offers to join or assign an alternative customer service representative to resolve the issue for the customer, and/or other feedback that assists the customer to resolve the issue. The live feedback for the customer may be provided as chat messages in the corresponding support chat session that is visible to the customer and the customer service representatives.

In at least one scenario, the monitoring module 222 may detect that the customer 108 has an outstanding in-store interaction event at the physical store 138. The monitoring module 222 may further detect via a reported geographical location of the user device 114 that the customer 108 is within a predetermined distance of the physical store 138. In such an instance, the monitoring module 222 may send a text message to the user device 114 to reminder the customer 108 of the outstanding in-store interaction event. The text message may be display by the customer chat application 112 on the user device 114 as part of a new chat session or as an event notification.

In an alternative scenario, the monitoring module 222 may detect that the customer 108 has an outstanding in-store interaction event for resolving an issue. The monitoring module 222 may further detect via a reported geolocation of the user device 114 that the customer 108 happens to be passing within a predetermined distance of a particular physical store that is able to resolve the issue for the customer 108. Accordingly, the monitoring module 222 may generate an alert text message with a recommendation that the customer 108 go into particular physical store to have the issue resolved.

However, in instances in which the resolution of the issue is contingent upon the expertise of a particular in-store customer service representative, the monitoring module 222 may send the text message when the particular representative is available or will be available within a predetermined time period when the customer 108 is passing by the particular physical store. In such an instance, the text message may indicate that the customer 108 is to reply with a designated time frame if the customer 108 is interested. Following the receipt of the reply of interest, the monitoring module 222 may use the schedule module 218 to generate an appointment with the particular customer service representative for the customer 108.

The evaluation module 224 may assess the performance of the customer service representatives in resolving issues for customers. In various embodiments, the evaluation module 224 may track multiple performance metrics related to customer service representative performance with respect to particular issues. Such metrics may include the duration of each support chat session, in which a shorter duration may increase the expertise rating of the customer service representative with respect to an issue. Conversely, a longer duration may decrease the expertise rating of the customer service representative with respect to an issue. Other metrics may include number of chat sessions handled in a predetermined time period, percentage of chat sessions that are marked as resolved by the customer service representative, and/or so forth. In such examples, a higher number of chat sessions pertaining to an issue handled may increase the expertise rating of the customer service representative with respect to the issue as compared to other customer service representatives with lower numbers handled. Similarly, a higher percentage of chat sessions pertaining to an issue that are marked as resolved may increase the expertise rating of the customer service representative with respect to the issue as compared to other customer service representatives with lower resolution percentages.

The evaluation module 224 may provide an electronic survey form to a customer following the end of a chat session. The survey form may ask the customer the specific technical area in which the customer is experience an issue, whether the issue experienced by the customer is successfully resolved, the expertise rating of each customer service representative involved in a chat session, whether the customer wants to interact again with each customer service representative, and/or so forth.

The evaluation module 224 may further take into consideration the number of times that a customer service representative declined to join a chat session for resolving an issue. For example, the evaluation module 224 may decrease the expertise rating of a customer service representative when the number of support chat sessions that the representative declined to join in a designated time period exceeds a threshold. On other hand, the evaluation module 224 may increase the expertise rating of a customer service representative when the customer service representative is able to join a predetermined number of chat sessions in a time period. In this way, the evaluation module 224 may refine an expertise rating of a customer service representative in each of multiple technical areas for storage in the expertise database 228.

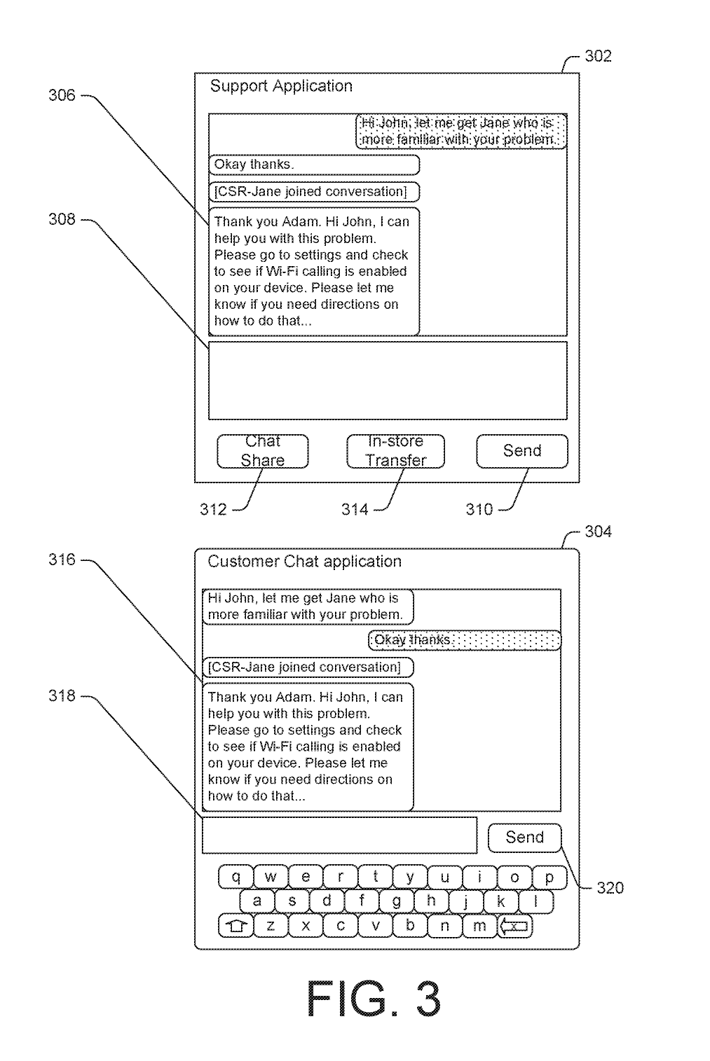

The data store 226 may store information that are used or processed by the support session engine 104. The data store 226 may include one or more databases, such as relational databases, object databases, object-relational databases, and/or key-value databases. The databases may include the expertise database 228, the expertise database 228, the chat log database 230, and the session information database 232. The chat log database 230 may store the chat logs of multiple chat sessions. The session information database 232 may store the session state information for various chat sessions, such as the session state information 128. The schedule database 234 may store information regarding the in-store interactions that are arranged by the schedule module 218. Additional details regarding the functionalities of the support session engine 104 are discussed in the context of FIGS. 3-7. Thus, the support session engine 104 may include other modules and databases that perform the functionalities described in the context of these figures.

### Example User Interfaces

FIG. 3 shows illustrative chat session interfaces for seamlessly sharing a support chat session with a customer between multiple customer service representatives. The chat session interface 302 may be generated by a support application of a customer service representative, while the chat session interface 304 may be generated by the customer chat application of a customer. As shown, the chat session interface 302 may include a portion 306 that displays the text of the chat between the customer service representative and the customer. The chat session interface 302 may further include a text input portion 308 that enables the customer service representative to input text into the chat session. Following the entry of a message, the customer service representative may activate the send control 310 to post the message into the chat session. The chat session interface 302 may further include a chat share control 312 and an in-store transfer control 314. The chat share control 312 may enables the customer service representative to initiate a share of the chat session so that another customer service representative may join the chat session. The in-store transfer control 314 may enable the customer service representative to initiate an in-store interaction between the customer and a customer service representative at a physical store of the wireless telecommunication carrier.

The chat session interface 304 may include a portion 316 that displays the text of the chat between the customer and the customer service representative. The chat session interface 304 may further include a text input portion 318 that enables the customer to input text into the chat session. Following the entry of a message, the customer may activate the send control 320 to post the message into the chat session.

### Example Processes

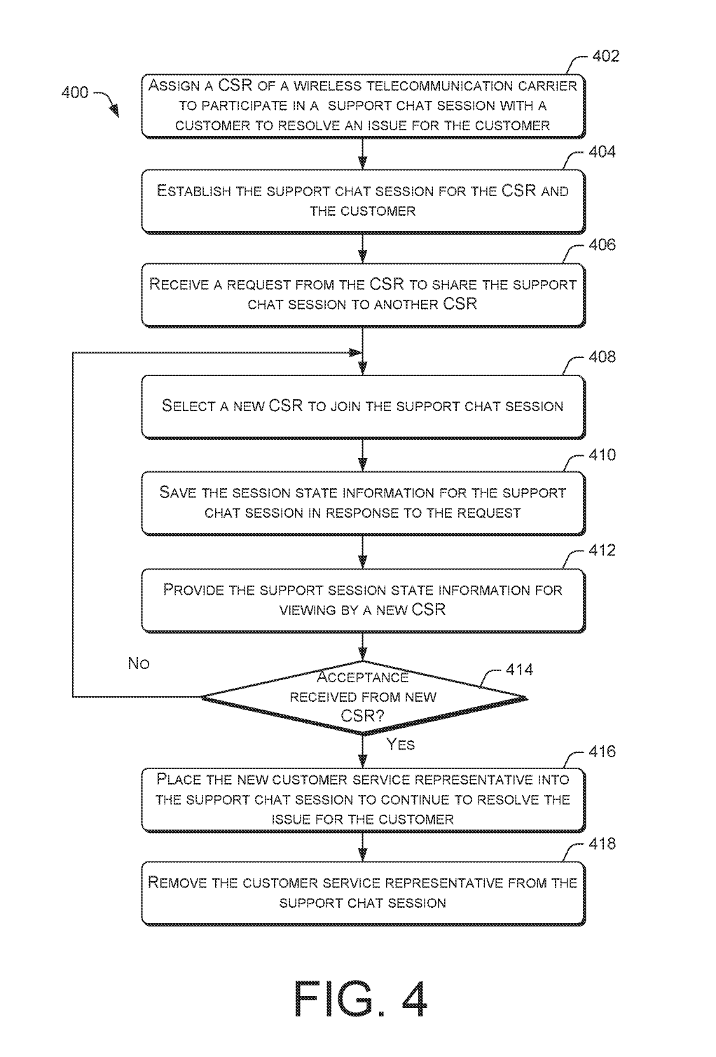

FIGS. 4-8 present illustrative processes 400-800 for seamlessly sharing a support chat session with a customer between multiple customer service representatives. Each of the processes 400-800 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 400-800 are described with reference to the architecture 100 of FIG. 1.

FIG. 4 is a flow diagram of an example process for seamlessly sharing a support chat session with a customer between multiple customer service representatives. At block 402, the support session engine 104 may assign a customer service representative of a wireless telecommunication carrier to participate in a support chat session with a customer to resolve an issue for the customer. The wireless telecommunication carrier may operate the wireless telecommunication network 102. The issue may be an issue that the customer is experiencing with a device or a service that is associated with the wireless telecommunication network 102. In various embodiments, the customer service representative may be assigned on a round robin basis, on a random basis, or based on the expertise of various customer service representatives with the issue.

At block 404, the support session engine 104 may establish a chat session for the customer service representative 110 and the customer 108. The chat session may be established such that the customer 108 and the customer service representative 110 may use corresponding participant identifiers to participate in session. The customer 108 may use the customer chat application 112 to participate in the chat session, while the customer service representative 110 may use the support application 116 to participate in the chat session.

At block 406, the support session engine 104 may receive a request from the customer service representative 110 to request another customer service representative to join the support chat session. The request may be initiated by the customer service representative 110 via the support application 116. In one example, the customer service representative may initiate such a share in an instance which the representative feels that the customer may benefit from additional and/or more in-depth expertise of another representative to resolve the issue.

At block 408, the support session engine 104 may select a new customer service representative, such as the escalated customer service representative 132, to join the support chat session. In various embodiments, the support session engine 104 may initially search for suitable customer service representatives that are currently available. Subsequently, the support session engine 104 may search among the available customer representatives for a suitable new customer service representative. The customer service representative may be selected on a round robin basis, on a random basis, or based on the expertise of various customer service representatives with the issue.

At block 410, the support session engine 104 may save the session state information 128 for the support chat session. In various embodiments, the session state information 128 may include a chat log of the chat session and other information that are relevant to the resolution of the issue.

At block 412, the support session engine 104 may provide the session state information 128 for viewing by the new customer service representative. For example, the session state information 128 may be forwarded to the support application 134 on the customer care terminal 130 of the new customer service representative 132.

At decision block 414, the support session engine 104 may determine whether an acceptance of the support chat session is received from the new customer service representative. For example, the new customer service representative 132 may signal the acceptance by sending an acceptance indication to the support session engine 104 via the support application 134. Accordingly, if the support session engine 104 determines that an acceptance is received from the new customer service representative (“yes” at decision block 414), the process 400 may proceed to block 416.

At block 416, the support session engine 104 may place the new customer service representative into the support chat session to jointly resolve the issue for the customer 108. For example, the escalated customer service representative 132 may access the chat session that is already in progress via the support application 134 that is on the customer care terminal 130. At block 418, the support session engine 104 may optionally remove the customer service representative 110 that was originally assisting the customer 108 from the support chat session. In various embodiments, the support session engine 104 may perform such removal by terminating the access of the customer service representative 110 to the support chat session. In at least one embodiment, the support session engine 104 may remove the customer service representative 110 upon a request from the customer 108 or the customer service representative 110.

However, if the support session engine 104 determines that no acceptance is received from the new customer service representative (“no” at decision block 414), the process 400 may loop back to block 412, such that the support session engine 104 may select another new customer service representative to join the support chat session.

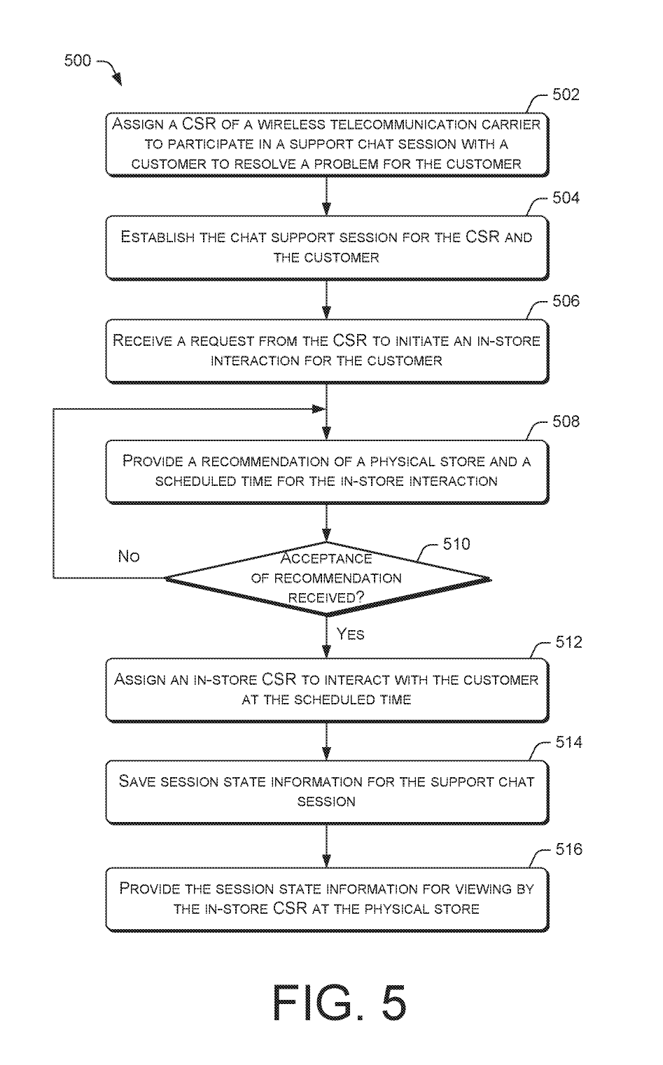

FIG. 5 is a flow diagram of an example process 500 for initiating an in-store interaction between a customer and an in-store customer service representative via a support chat session. At block 502, the support session engine 104 may assign a customer service representative of a wireless telecommunication carrier to participate in a support chat session with a customer to resolve an issue for the customer. The wireless telecommunication carrier may operate the wireless telecommunication network 102. The issue may be a service issue that the customer is experiencing with a device or a service that is associated with the wireless telecommunication network 102. In various embodiments, the customer service representative may be assigned on a round robin basis, on a random basis, or based on the expertise of various customer service representatives with the issue.

At block 504, the support session engine 104 may establish a chat session for the customer service representative 110 and the customer. The chat session may be established such that the customer 108 and the customer service representative 110 may use corresponding participant identifiers to participate in session. The customer 108 may use the customer chat application 112 to participate in the chat session, while the customer service representative 110 may use the support application 116 to participate in the chat session.

At block 506, the support session engine 104 may receive a request from the customer service representative 110 to initiate an in-store interaction for the customer 108. The request may be initiated by the customer service representative 110 via the support application 116. For example, the customer service representative 110 may determine that the customer has a device issue that is best resolved in person at a physical store of the wireless telecommunication carrier.

At block 508, the support session engine 104 may provide a recommendation of a physical store and a scheduled time for the in-store interaction. The scheduled time may be selected based on a preference input of the customer. In some embodiments, the support session engine 104 may automatically detect a current geographical location of the user device 114, and select an open physical store at a location that is closest to the current geographical location of the user device 114. The support session engine 104 may further verify that the open physical store has an available customer service representative to assist the customer at the preferred time for the store visit before selecting the physical store. In other embodiments, the customer service representative may select an open physical store based on a desired location or geographical area indicated by an input of the customer.

At decision block 510, the support session engine 104 may determine whether an acceptance of the recommendation by the customer 108 is received. The customer 108 may provide an acceptance indication to the support session engine via the customer chat application 112. Accordingly, if the support session engine 104 determines that an acceptance indication is received from the customer 108 (“yes” at decision block 510), the process 500 may proceed to block 512.

At block 512, the support session engine 104 may assign an in-store customer service representative to interact with the customer at the scheduled time. In some embodiments, the in-store customer service representative may be selected by the support session engine 104 based on expertise. In other embodiments, the in-store customer service representative may be selected on a round robin or random basis. Alternatively, the selected in-store customer service representative may be a representative that takes care of tasks in a common queue.

At block 514, the support session engine 104 may save the session state information 128 for the support chat session. In various embodiments, the session state information 128 may include a chat log of the chat session and other information that are relevant to the resolution of the issue.

At block 516, the support session engine 104 may provide the session state information 128 for viewing by the in-store customer service representative at the physical store. For example, the session state information 128 may be forwarded to the support application 140 on the secure terminal 142 of the in-store customer service representative 136. Alternatively or concurrently, the support session engine 104 may also provide the request information associated with the in-store interaction request for viewing by the in-store customer service representative 136.

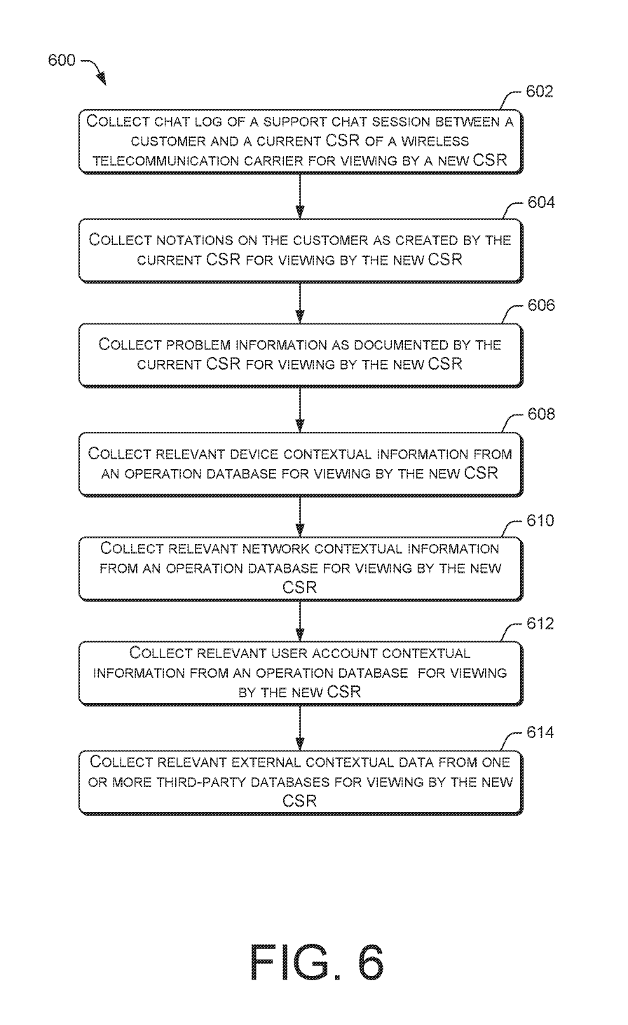

FIG. 6 is a flow diagram of an example process for collecting session state information of a support chat session for sharing with another customer service representative. In various embodiments, the process 600 may further describe block 410 of the process 400 and block 514 of the process 500. At block 602, the support session engine 104 may collect the chat log of a support chat session between a customer and a current of a wireless telecommunication carrier for viewing by a new customer service representative. The chat log may include the text messages that are exchanged between the customer and the current customer service representative. Additionally, the chat log may include metadata about the text message, such as creation and/or receipt time and date stamps, message delivery status, message routing information, and/or so forth.

At block 604, the support session engine 104 may collect notations on the customer as created by the current customer service representative for viewing by the new customer service representative. In various embodiments, the notations may record subject observations of the customer service representative 110 on the customer 108. For example, the notifications may include notes on communication styles that work well with the customer 108, notes on the likes and dislikes of the customer 108, and/or so forth.

At block 606, the support session engine 104 may collect problem information as documented by the current customer service representative for viewing by the new customer service representative. In various embodiments, the problem information may recite factual data about the issue, such as date and time the issue first occurred, the location of the affected user device when the issue occurred, the duration of the issue, the symptoms experienced by the customer 108 with respect to the issue, attempted solutions for the issue, and/or so forth.

At block 608, the support session engine 104 may collect relevant device contextual information from an operation database for review by the new customer service representative. In various embodiments, the device contextual information of a user device may indicate the technical capabilities, feature settings, and operational statuses of the user device. For example, device information for the user device 114 may indicate that Wi-Fi calling is enabled on the user device or that the user device is capable of using a specific communication band provided by the wireless telecommunication network.

At block 610, the support session engine 104 may collect relevant network contextual information from an operation database for review by the new customer service representative. In various embodiments, the network information may include information regarding the technical and operational status of the wireless telecommunication network.

At block 612, the support session engine 104 may collect relevant user account contextual information from an operation database for review by the new customer service representative. In various embodiments, the user account information for a customer may include account details of multiple users, such as account type, billing preferences, service plan subscription, payment history, data consumed, minutes of talk time used, and/or so forth.

At block 614, the support session engine 104 may collect relevant external contextual data from one or more third-party databases for review by the new customer service representative. In various embodiments, the external contextual data may include regulatory information for networks and devices, device manufacturer information, credit information on users, social media data, and/or so forth.

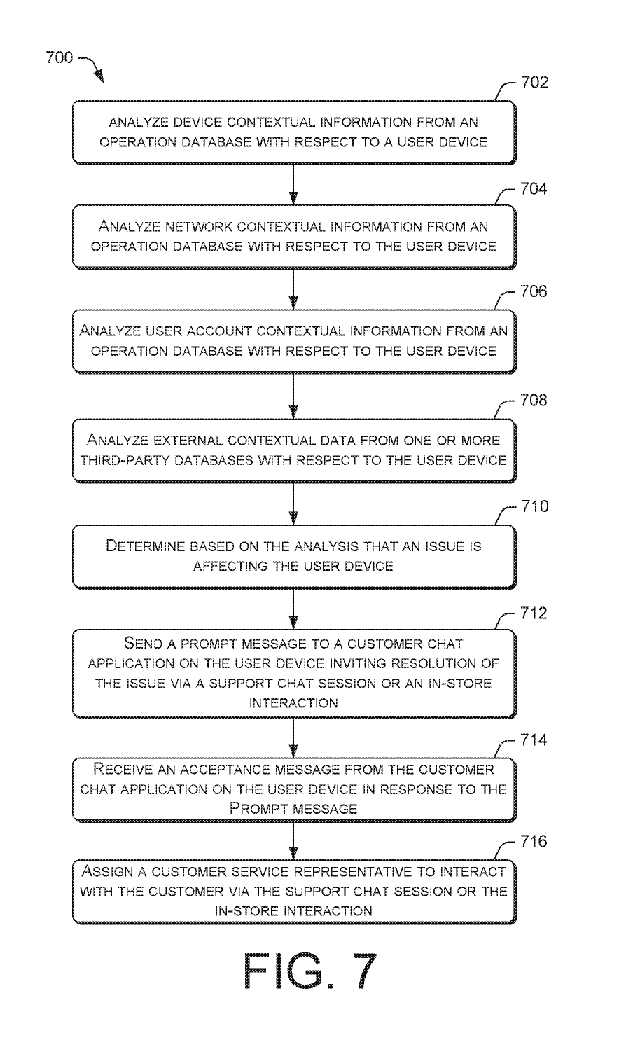

FIG. 7 is a flow diagram of an example process for inviting a customer to engage in a support chat session or an in-store interaction with a customer service representative. At block 702, the support session engine 104 may analyze device contextual information from an operation database with respect to a user device. In various embodiments, the device contextual information of a user device may indicate the technical capabilities, feature settings, and operational statuses of the user device. For example, device information for the user device 114 may indicate that Wi-Fi calling is enabled on the user device or that the user device is capable of using a specific communication band provided by the wireless telecommunication network.

At block 704, the support session engine 104 may analyze network contextual information from an operation database with respect to the user device. In various embodiments, the network information may include information regarding the technical and operational status of the wireless telecommunication network that may affect the user device.

At block 706, the support session engine 104 may analyze user account contextual information from an operation database with respect to the user device. In various embodiments, the user account information for a customer may include account details of multiple users, such as account type, billing preferences, service plan subscription, payment history, data consumed, minutes of talk time used, and/or so forth that may affect the operation of the user device.

At block 708, the support session engine 104 may analyze external contextual data from one or more third-party databases with respect to the user device. In various embodiments, the external contextual data may include regulatory information for the user device, device manufacturer information for the user device, credit information on the customer of the user device, social media data on the user device, and/or so forth.

At block 710, the support session engine 104 may determine based on the analysis of the one or more databases that an issue is affecting the user device. For example, the issue may be a hardware issue, such as a user device charging cable or a battery recall that is identified based on a third-party database 126 in the form of a manufacturer database. In another example, the issue may be a software problem or a software setting problem that causes the user device to be susceptible to a particular malicious attack, in which the issue is identified based on information from an operation database 122 in the form of a device information database.

At block 712, the support session engine 104 may send a prompt message to a customer chat application on the user device inviting the customer to resolving the issue via a support chat session or an in-store interaction. For example, if there is a faulty software setting on the user device, the prompt message may suggest that the customer enter into a support chat session to have a customer representative guide the customer to fix the faulty software setting. In another example, the prompt message may indicate that the customer can receive a replacement for a recalled charging cable or battery free of charge at a physical store.

At block 714, the support session engine 104 may receive an acceptance message from the customer chat application on the user device in response to the prompt message. For example, the prompt message may specify that the customer may accept the invitation by sending an acceptance message with the text “okay”, and the customer may perform such an action.

At block 716, the support session engine 104 may assign a customer service representative to interact with the customer via the support chat session or the in-store interaction, as originally specified in the prompt message. In at least some embodiments, the customer service representative may be selected from among multiple customer representatives based on the expertise ratings of the representatives in dealing with the issue. In other words, the selected customer service representative may be an available representative that has the most expertise in dealing with the issue.

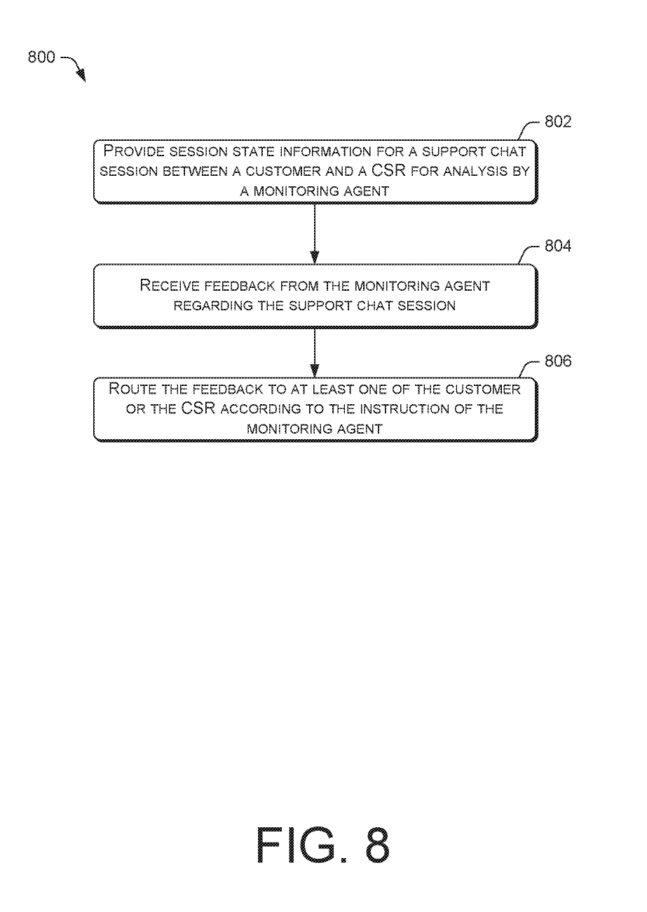

FIG. 8 is a flow diagram of an example process 800 for a monitoring agent to provide synchronous or asynchronous feedback regarding a support chat session between a customer and a customer service representative. At block 802, the support session engine 104 may provide session state information for a support chat session between a customer and a customer service representative for analysis by a monitoring agent. In various embodiments, the session state information 128 may include a chat log of the chat session and other information that are relevant to the chat session. The monitoring agent may be a live person (e.g., a supervisor of the customer service representative) or an analytic software (e.g., a data analysis application). The support session engine 104 may provide the session state information to the monitoring agent in real-time or on a periodic basis.

At block 804, the support session engine 104 may receive feedback from the monitoring agent regarding the support chat session. Accordingly, in instances in which the support chat session is being reviewed in real-time, the monitoring module 222 may provide synchronous, i.e., live, feedback on the session. However, in instances in which the support chat session is being reviewed on a periodic basis, i.e., in non-real time, the monitoring module 222 may provide asynchronous, i.e., post-event, feedback on the session.

At block 806, the support session engine 104 may route the feedback to at least one of the customer or the customer service representative according to the instruction of the monitoring agent. The feedback for the customer service representative may include hints of questions to ask the customer, tips on dealing with the customer, suggestions of alternative remedies to the issue of the customer, links to relevant contextual data related to the issue of the customer, and/or so forth. The feedback for the customer may include suggestions of alternative remedies to the issue of the customer, offers to join or assign an alternative customer service representative to resolve the issue for the customer, and/or other feedback that assists the customer in resolving the issue.

The seamless sharing of a support chat session with a customer between multiple customer service representatives may enable new customer service representatives to assist a customer with a service issue. In some embodiments, the new customer service representative may be an escalated customer service representative with the additional and/or more in-depth expertise to better assist the customer with the service issue. By reviewing the saved chat log and other relevant information, each new customer service representative is able to assist the customer using the same chat session without having the customer repeating a description of the service issue. Further, a support chat session may be used to seamlessly initiate an in-store interaction between the customer and an in-store customer service representative. Thus, the techniques may increase customer satisfaction and customer retention by providing attentive service to the customer.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
establishing a support chat session for a customer service representative to resolve an issue for a customer via text message exchange, the support chat session being implemented via a customer chat application on a user device of the customer and a support application on a customer care terminal of the customer service representative;
receiving a request initiated from the support application of the customer service representative to share the support chat session with a new customer service representative;
saving session state information for the support chat session in response to the request initiated from the support application of the customer service representative, the session state information including a chat log of text messages exchanged between the customer and the customer service representative; and
placing the new customer service representative into the support chat session, the new customer service representative participating in the support chat session via a new support application on a new customer service terminal.

2. The one or more non-transitory computer-readable media of claim 1, wherein the acts further comprise assigning the customer service representative to the support chat session based on descriptors of expertise of the customer service representative.

3. The one or more non-transitory computer-readable media of claim 1, wherein the acts further comprise at least one of:
terminating the participation of the customer service representative in the support chat session following placement of new customer service representative into the support chat session; or
suspending the support chat session for a resumption of the support chat session with the customer service representative or the new customer service representative.

4. The one or more non-transitory computer-readable media of claim 1, wherein the acts further comprise:
receiving a request from the new customer service representative that is engaged in the support chat session with a customer to initiate an in-store interaction for the customer to resolve the issue, the in-store interaction enabling the customer to interact in person with an in-store customer service representative at a physical store;
providing a recommendation of a specific physical store and a scheduled time for the in-store interaction;
assigning a specific in-store customer service representative to interact in person with the customer at the physical store in response to receiving an acceptance of the recommendation by the customer through the support chat session;
saving new session state information that includes a new chat log of a new text message between the customer and the new customer service representative; and
providing the session state information for viewing by the specific in-store customer service representative via a corresponding support application on a secure terminal of the in-store customer service representative.

5. The one or more non-transitory computer-readable media of claim 4, wherein the acts further comprise:
receiving an indication from the specific in-store customer service representative that declines the in-store interaction with the customer;
assigning a new in-store customer service representative to interact in person with the customer at the physical store; and
providing the session state information for viewing by the new in-store customer service representative.

6. The one or more non-transitory computer-readable media of claim 5, wherein the acts further comprise assigning an expertise rating to the customer service representative, the new customer service representative, or the in-store customer service representative based on a performance of a corresponding customer service representative in resolving the issue for the customer.

7. The one or more non-transitory computer-readable media of claim 4, wherein the assigning the in-store customer service representative includes assigning the in-store customer service representative based on descriptors of expertise of the in-store customer service representative.

8. The one or more non-transitory computer-readable media of claim 1, wherein an in-store interaction is arranged for the customer via the support chat session between the customer and the customer service representative, and wherein the acts further comprise:
detecting based on a geolocation of a user device that the customer is within a predetermined distance of a physical store with an in-store customer service representative that is able to assist the customer; and
sending an alert to the customer chat application of the customer recommending that the customer visit the physical store to interact with the in-store customer service representative.

9. The one or more non-transitory computer-readable media of claim 1, wherein the acts further comprise:
providing the session state information for the support chat session between the customer and the customer service representative for analysis by a monitoring agent that is a live person or a data analysis application;
receiving feedback from the monitoring agent regarding the support chat session, the feedback including synchronous feedback when the session state information is analyzed in real time, or asynchronous feedback when the session state information is analyzed post the support chat session; and
routing the feedback to at least one of the customer or the customer service representative.

10. The one or more non-transitory computer-readable media of claim 1, wherein the issue affects an operation of the user device on a wireless telecommunication network, and wherein the session state information includes at least one of network contextual information regarding technical and operational status of the wireless telecommunication network, device contextual information regarding technical capabilities, feature settings, and operational status of the user device, account contextual information that includes account details associated with the user device, or a third-party database that provides external information.

11. The one or more non-transitory computer-readable media of claim 10, wherein the external information includes one or more of manufacturer information regarding the user device, regulatory information for the wireless telecommunication network or the user device, credit information of the customer, or social media information aggregated from one or more social media sources regarding an issue that affects the wireless telecommunication network.

12. The one or more non-transitory computer-readable media of claim 1, wherein the session state information further includes at least one of a notation on the customer as created by the customer service representative, or problem information regarding the issue as documented by the customer service representative.

13. A computer-implemented method, comprising:
determining based on information from one or more databases that an issue is affecting a user device, the one or more databases including an operational database of a wireless telecommunication network or a third-party database that is external to the wireless telecommunication network;
sending a prompt message to a customer chat application on the user device inviting the customer to interact with a customer service representative via a support chat session or via an in-store interaction to resolve the issue;
receiving an acceptance message from the customer chat application on the user device in response to the prompt message; and
assigning an available customer service representative to interact with the customer via the customer chat application or to provide the in-store interaction with the customer at an available physical store to resolve the issue in response to the acceptance message.

14. The computer-implemented method of claim 13, further comprising:
establishing, via one or more computing devices, an additional support chat session for an additional customer service representative to resolve an additional issue for the customer via text message exchange, the additional support chat session being implemented via the customer chat application on the user device of the customer and a support application on a customer care terminal of the additional customer service representative;
receiving, at the one or more computing devices, a request from the additional customer service representative to initiate an additional in-store interaction for the customer, the additional in-store interaction enabling the customer to interact in person with an in-store customer service representative at an additional physical store;
providing, via the one or more computing devices, a recommendation of a specific physical store and a scheduled time for the additional in-store interaction;
assigning, via the one or more computing devices, a specific in-store customer service representative to interact in person with the customer at the specific physical store in response to receiving an acceptance of the recommendation by the customer through the additional support chat session;
saving, via the one or more computing devices, session state information that includes a chat log of text messages exchanged between the customer and the customer service representative; and
providing, via the one or more computing devices, the session state information for viewing by the specific in-store customer service representative via a corresponding support application on a secure terminal of the specific in-store customer service representative.

15. The computer-implemented method of claim 14, wherein the assigning a customer service representative includes assigning the in-store customer service representative based on an expertise of the in-store customer service representative with resolving the issue or the additional issue.

16. The computer-implemented method of claim 14, further comprising:
detecting based on a geolocation of a user device that the customer is within a predetermined distance of the specific physical store with the in-store customer service representative that is able to assist the customer; and
sending an alert to the customer chat application on the user device of the customer recommending that the customer visit the specific physical store to interact with the specific in-store customer service representative.

17. The computer-implemented method of claim 14, wherein the issue or the additional issue affects an operation of the user device on a wireless telecommunication network, and wherein the session state information includes at least one of network contextual information regarding technical and operational status of the wireless telecommunication network, device contextual information regarding technical capabilities, feature settings, and operational status of the user device, account contextual information that includes account details associated with the user device, or a third-party database that provides external information.

18. A system, comprising:
one or more processors; and
memory including a plurality of computer-executable components that are executable by the one or more processors to perform a plurality of actions, the plurality of actions comprising:
establishing a support chat session for a customer service representative of a wireless telecommunication carrier to resolve a telecommunication service issue for a customer via text message exchange, the support chat session being implemented via a customer chat application on a user device of the customer and a support application on a customer care terminal of the customer service representative, the customer service representative being selected based on an expertise of the customer service representative with the telecommunication service issue;
receiving a request initiated from the support application of the customer service representative to share the support chat session with an escalated customer service representative that has more expertise with the telecommunication service issue than the customer service representative;
saving session state information for the support chat session in response to the request initiated from the support application of the customer service representative, the session state information including a chat log of text messages exchanged between the customer and the customer service representative; and
placing the escalated customer service representative into the support chat session to join in resolving the telecommunication service issue for the customer in response to the escalated customer service representative indicating an agreement to join the support chat session, the escalated customer service representative participating in the support chat session via a new support application on a new customer service terminal.

19. The system of claim 18, wherein the plurality of actions further comprises selecting an additional customer service representative to join the support chat session in response to the escalated customer service representative declining to join the support chat session following the review of the session state information.

20. The system of claim 19, wherein the escalated customer service representative or the additional customer service representative is selected for assignment to the support chat session based on descriptors of expertise of the customer service representative with the telecommunication service issue experienced by the customer.
